(19) United States
(12) Patent Application Publication
(10) Pub. No.: US 2025/0188273 A1
(43) Pub. Date: Jun. 12, 2025

(54) POLYCARBONATE-POLYESTER COMPOSITION AND COMPONENT HAVING A HIGH COMPARATIVE TRACKING INDEX

(71) Applicant: Covestro Deutschland AG, Leverkusen (DE)

(72) Inventors: Marius Nolte, Köln (DE); Matthias Knaupp, Langenfeld (DE); Tim Hungerland, Köln (DE)

(21) Appl. No.: 18/845,570

(22) PCT Filed: Mar. 16, 2023
(86) PCT No.: PCT/EP2023/056723

§ 371 Date: Sep. 10, 2024

(30) Foreign Application Priority Data
Mar. 25, 2022 (EP) 22164257.2

(51) Int. Cl. C08L 69/00; C08K 3/24; C08K 5/103; C08K 5/134; C08K 5/521

(52) U.S. Cl. CPC C08L 69/00; C08K 3/24; C08K 5/103; C08K 5/134; C08K 5/521; C08L 2201/02; C08L 2203/20; C08L 2205/035; C08L 2207/53

(57) ABSTRACT

The present invention relates to a composition containing A) 60 to 93 wt. % of at least one aromatic polycarbonate, polyester carbonate or mixtures thereof, B) 2 to 20 wt. % of a polyester on the basis of an aromatic or cycloaliphatic dicarboxylic acid or mixtures thereof and cyclohexane dimethanol and optionally an additional aliphatic diol, and C) 1 to 20 wt. % of at least one phosphorus-containing flame retardant. The invention also relates to a component that contains the composition and to the use of components B and C in the indicated quantities in order to improve CTI and flame retardancy of polycarbonate compositions.

The present invention relates to a flame-retardant polycarbonate/polyester composition, to a component having high tracking resistance comprising the composition, and to the use of a specific polyester and a flame retardant for improving tracking resistance and flame retardancy in polycarbonate compositions.

Polycarbonates and polycarbonate blend compositions have been used for many years for numerous applications such as in automotive construction, in the electronics field and in the construction sector. Polycarbonate and polycarbonate blends are notable for high heat distortion resistance and high toughness. The selection and amount of polymeric blend partners in particular make it possible to vary the overall profile of properties within wide ranges and to adapt it to the respective requirements.

For electronics applications, good insulation properties and a high flame retardancy are highly relevant in terms of safety. Such requirements are becoming increasingly important for example also in the field of electromobility. If the polymeric material is in direct contact with current-carrying parts such as conductor tracks, then a high tracking resistance is also important. Tracking currents can otherwise cause charge to be transferred via the surface of the plastic over further distances than would be possible directly through the air at the same voltage. This is even the case with materials that intrinsically have high insulating properties, such as plastics. The tendency toward tracking current formation should therefore be as low as possible in order to reduce the risk of short circuits and thus to avoid fires. In addition, a high tracking resistance makes it possible to reduce the distances between for example electrical conductor tracks and thus to achieve smaller component sizes or to operate the components with higher operating voltages.

The CTI (“comparative tracking index”) is a measure for the tracking resistance of a plastic. This makes it possible to express the extent to which the surface of the plastic enables the formation of tracking currents due to the influence of dirt or liquid when an electrical voltage is applied. The higher the tracking resistance, the better the material is suited for components to which high voltages are applied and/or which during use can become dirty or come into contact with moisture. The CTI is given in volts and states that up to this voltage no significant tracking current occurs in the case of the droplet application of a certain amount of an electrolyte solution.

In comparison with other polymers such as polyethylene, polycarbonate has only a low tracking resistance with a CTI value of about 250 V. However, CTI values of 600 V are required for some high-voltage applications, such as in the field of electromobility. Furthermore, the materials for such applications should have a very high flame retardancy according to UL 94 V, preferably a classification of V0 at thin wall thicknesses such as 1.5 mm.

The flame retardancy of polycarbonate and polycarbonate blends is usually improved by the addition of flame retardants.

US 2007/197722 A1 discloses a thermoplastic molding composition with improved impact resistance and flame resistance. The composition The composition contains (a) aromatic polycarbonate, (b) thermoplastic polyester, (c) halogenated acrylate, (d) an impact modifier, (e) a phosphorus-containing compound, and (f) fluorinated polyolefin.

US 2012/231278 discloses compositions having improved flame retardancy for extrusion applications containing aromatic polycarbonate, an acrylate-based scattering additive, brominated flame retardant and phosphorus-based flame retardant.

However, some flame retardants increase the tendency toward tracking current formation, and thus result in an undesirable lowering of the CTI. Furthermore, flame retardants often also have a negative influence on the heat distortion resistance and the toughness such as the impact strength.

EP 3560997 A2 discloses a thermoplastic resin composition which has good properties such as high CTI and comprises: (A) 100 parts by weight of polycarbonate; (B) 2 parts by weight to 6 parts by weight of a cyclic phosphazene compound flame retardant; (C) 0.1 part by weight to 5 parts by weight of an impact modifier; and (D) 1 part by weight to 3 parts by weight of a fluorinated polyolefin.

US 2012/0248384 A1 discloses polycarbonate compositions, methods and articles of manufacture that meet at least certain electrical tracking resistance requirements. The compositions, methods and articles of manufacture that meet these requirements contain at least a polycarbonate, a polysiloxane block copolycarbonate and a transition metal oxide, for example titanium dioxide.

The relationships between fire behavior (GWFI) and tracking resistance are discussed in the publication: “Glow wire ignition temperature (GWIT) and comparative tracking index (CTI) of glass fibre filled engineering polymers, blends and flame retarded formulations” (Polymer Degradation and Stability, Volume 96, Issue 12, December 2011, pages 2098-2103).

It was further desirable to provide polycarbonate compositions from which molded articles can be produced, which feature the combination of high CTI, high flame retardancy, high heat distortion resistance and toughness. In particular, it was desirable for the molded articles to have a CTI of 600 V, preferably determined according to the rapid test method, as described in the Examples section, based on IEC 60112:2009, a UL 94 V0 classification at 1.5 mm, and further preferably additionally a Vicat softening temperature measured according to DIN ISO 306 (2013 version, Method B/120) of at least 105° C. and no fracture in the Izod impact strength test according to ISO 180-U (2019 version).

Surprisingly, it has been found that a composition comprising
A) 60% to 93% by weight, preferably 65% to 90% by weight, particularly preferably 70% to 90% by weight, of at least one aromatic polycarbonate, polyestercarbonate or mixtures thereof,
B) 2% to 20% by weight, preferably 3% to 18% by weight, particularly preferably 4% to 16% by weight, of a polyester based on at least one aromatic or at least one cycloaliphatic dicarboxylic acid or mixtures thereof and cyclohexanedimethanol and optionally at least one further aliphatic diol,
C) 1% to 10% by weight, preferably 2% to 9% by weight, particularly preferably 3% to 9% by weight, of at least one phosphorus-containing flame retardant
has the desired properties.

In addition to components A, B and C, the composition may comprise, as component D, one or more polymer additives, fillers and reinforcers, dyes, pigments, impact modifiers and/or polymers different from components A and B as blend partners, with the amount of component D preferably being 0.1% to 20% by weight, based on the composition.

The composition preferably consists to an extent of at least 90% by weight, further preferably to an extent of at least 95% by weight, of components A to D. Particularly preferably, the composition consists solely of components A to D.

The present invention further provides for the use of 2% to 20% by weight of a polyester based on an aromatic or cycloaliphatic dicarboxylic acid or mixtures thereof and cyclohexanedimethanol and optionally a further aliphatic diol and
1% to 10% by weight of at least one phosphorus-containing flame retardant for improving the CTI and the flame retardancy according to UL 94 V of polycarbonate compositions, preferably for attaining a CTI of 600 V preferably determined according to the rapid test method, as described in the Examples section, based on IEC 60112:2009 and a UL 94 V0 classification at a test specimen thickness of 1.5 mm of polycarbonate compositions comprising 60% to 93% by weight of polycarbonate.

On account of the good properties of the composition, it is also suitable for the production of components that have a small distance between electrical conductor tracks.

The present invention therefore further provides a component, preferably an electrical/electronic component,
comprising
a first electrical conductor L1 and a second electrical conductor L2 at a first distance d1 and a second distance d2 with respect to one another,
which are connected via a thermoplastic material M which is in direct contact with the first electrical conductor and the second electrical conductor,
wherein the distance d1 is the shortest distance between the first electrical conductor and the second electrical conductor along the surface of the thermoplastic material M and
wherein the distance d2 is the shortest distance between the first electrical conductor and the second electrical conductor through the air,
wherein d2 is selected in such a way that at the respective operating voltage U for the component a sparkover through the air is prevented,
   wherein d1, at the operating voltages U listed below, has the following values:

$$d 1 ( 0 V \leq U \leq 250 V ) : 1.3 mm to < 4. mm \\ d 1 ( 250 V < U \leq 500 V ) = 2.5 mm to < 8. mm \\ d 1 ( 500 V < U \leq 1000 V ) = 5. mm to < 16 mm$$

and wherein the thermoplastic material M comprises the following components
A) 60% to 93% by weight of at least one aromatic polycarbonate, polyestercarbonate or mixtures thereof,
B) 2% to 20% by weight of polyester based on at least one aromatic or at least one cycloaliphatic dicarboxylic acid or mixtures thereof and cyclohexanedimethanol and optionally at least one further aliphatic diol,
C) 1% to 10% by weight of at least one phosphorus-containing flame retardant.

Preferably, the component is one that has an IP6K9K degree of protection according to ISO 20653:2013, i.e. against contact, ingress of foreign bodies and water. For such components, d1, at the operating voltages U listed below, has the following values:
d1(0 V≤U≤250 V): 1.3 mm to <2.5 mm, further preferably 1.3 to <1.8 mm
d1(250 V<U≤500 V)=2.5 mm to <5.0 mm, further preferably 2.5 to <3.6 mm
d1(500 V<U≤1000 V)=5.0 mm to <10.0 mm, further preferably 5.0 to <7.1 mm

d2 in this case is preferably at least 1.2 mm, further preferably 1.2 to 10.0 mm. Those skilled in the art are capable of determining the distance with which a sparkover through the air is prevented.

The features mentioned as preferred, particularly preferred, and so on, for the composition also apply with regard to the use according to the invention and the component according to the invention.

### Component A

Aromatic polycarbonates and/or aromatic polyestercarbonates according to component A which are suitable according to the invention are known from the literature or can be produced by processes known from the literature (for the production of aromatic polycarbonates see, for example, Schnell, “Chemistry and Physics of Polycarbonates”, Interscience Publishers, 1964, and DE-AS 1 495 626, DE-A 2 232 877, DE-A 2 703 376, DE-A 2 714 544, DE-A 3 000 610, DE-A 3 832 396; for the production of aromatic polyestercarbonates, for example DE-A 3 007 934).

Aromatic polycarbonates are produced for example by reaction of diphenols with carbonyl halides, preferably phosgene and/or with aromatic dicarbonyl dihalides, preferably benzenedicarbonyl dihalides, by the interfacial process, optionally using chain terminators, for example monophenols, and optionally using trifunctional or more than trifunctional branching agents, for example triphenols or tetraphenols. Production via a melt polymerization process by reaction of diphenols with for example diphenyl carbonate is likewise possible.

Diphenols for the production of the aromatic polycarbonates and/or aromatic polyestercarbonates are preferably those of formula (1)

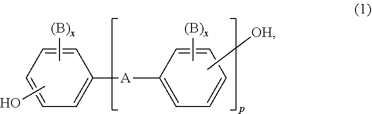

where
A is a single bond, C₁- to C₅-alkylene, C₂- to C₅-alkylidene, C₅- to C₆-cycloalkylidene, —O—, —SO—, —CO—, —S—, —SO₂—, C₆- to C₁₂-arylene, onto which further aromatic rings optionally containing heteroatoms may be fused,
   or a radical of formula (2) or (3)

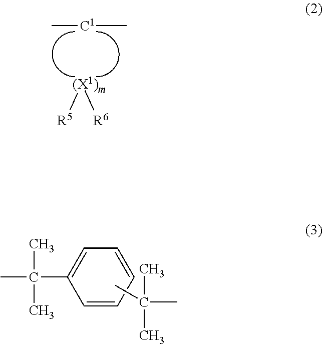

B is in each case C₁- to C₁₂-alkyl, preferably methyl, halogen, preferably chlorine and/or bromine,
x is in each case independently 0, 1 or 2,
p is 1 or 0, and
R⁵ and R⁶ can be selected individually for each X₁ and are each independently hydrogen or C₁- to C₆-alkyl, preferably hydrogen, methyl or ethyl,
X¹ is carbon and
m is an integer from 4 to 7, preferably 4 or 5, with the proviso that, on at least one atom X¹, R⁵ and R⁶ are both alkyl.

Preferred diphenols are hydroquinone, resorcinol, dihydroxydiphenols, bis(hydroxyphenyl)-C₁-C₅-alkanes, bis(hydroxyphenyl)-C₅-C₆-cycloalkanes, bis(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropylbenzenes, and the ring-brominated and/or ring-chlorinated derivatives thereof.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulfide, 4,4′-dihydroxydiphenyl sulfone, and the di- and tetrabrominated or chlorinated derivatives thereof, such as 2,2-bis(3-chloro-4-hydroxyphenyl)propane, 2,2-bis(3,5-dichloro-4-hydroxyphenyl)propane or 2,2-bis(3,5-dibromo-4-hydroxyphenyl) propane. 2,2-Bis(4-hydroxyphenyl)propane (bisphenol A) is especially preferred.

The diphenols may be used individually or in the form of any desired mixtures. The diphenols are known from the literature or obtainable by processes known from the literature.

Examples of chain terminators suitable for the production of the thermoplastic aromatic polycarbonates include phenol, p-chlorophenol, p-tert-butylphenol or 2,4,6-tribromophenol, but also long-chain alkylphenols, such as 4-[2-(2,4,4-trimethylpentyl)]phenol, 4-(1,3-tetramethylbutyl)phenol according to DE-A 2 842 005 or monoalkylphenol or dialkylphenols having a total of 8 to 20 carbon atoms in the alkyl substituents, such as 3,5-di-tert-butylphenol, p-isooctylphenol, p-tert-octylphenol, p-dodecylphenol and 2-(3,5-dimethylheptyl) phenol and 4-(3,5-dimethylheptyl) phenol. The amount of chain terminators to be used is generally between 0.5 mol % and 10 mol %, based on the molar sum of the diphenols used in each case.

The thermoplastic aromatic polycarbonates have average molecular weights (weight average M_{w}) of preferably 20 000 to 40 000 g/mol, further preferably 22 000 to 32 000 g/mol, particularly preferably 24 000 to 30 000 g/mol, measured by GPC (gel permeation chromatography) calibrated against bisphenol A polycarbonate standards using dichloromethane as eluent, calibration with linear polycarbonates (formed from bisphenol A and phosgene) of known molar mass distribution from PSS Polymer Standards Service GmbH, Germany, and calibration by method 2301-0257502-09D (2009 German-language edition) from Currenta GmbH & Co. OHG, Leverkusen. The eluent is dichloromethane. Column combination of crosslinked styrene-divinylbenzene resins. Diameter of the analytical columns: 7.5 mm; length: 300 mm. Particle sizes of the column material: 3 μm to 20 μm. Concentration of the solutions: 0.2% by weight. Flow rate: 1.0 ml/min, temperature of solutions: 30° C. Use of UV and/or RI detection.

The preferred ranges result in a particularly advantageous balance of mechanical and rheological properties in the compositions according to the invention.

The thermoplastic aromatic polycarbonates may be branched in a known manner, and preferably through incorporation of 0.05 to 2.0 mol %, based on the sum total of the diphenols used, of trifunctional or more than trifunctional compounds, for example those having three or more phenolic groups. Preference is given to using linear polycarbonates, further preferably ones based on bisphenol A.

Both homopolycarbonates and copolycarbonates are suitable. Copolycarbonates according to the invention according to component A may also be produced using 1% to 25% by weight, preferably 2.5% to 25% by weight, based on the total amount of diphenols to be used, of polydiorganosiloxanes having hydroxyaryloxy end groups. These are known (U.S. Pat. No. 3,419,634) and can be produced by processes known from the literature. Likewise suitable are polydiorganosiloxane-containing copolycarbonates; the production of polydiorganosiloxane-containing copolycarbonates is described for example in DE-A 3 334 782.

Aromatic dicarbonyl dihalides for the production of aromatic polyestercarbonates are preferably the diacyl dichlorides of isophthalic acid, of terephthalic acid, of diphenyl ether 4,4′-dicarboxylic acid and of naphthalene-2,6-dicarboxylic acid.

Particular preference is given to mixtures of the diacyl dichlorides of isophthalic acid and of terephthalic acid in a ratio between 1:20 and 20:1.

In the production of polyestercarbonates, a carbonyl halide, preferably phosgene, is also additionally used as bifunctional acid derivative.

Useful chain terminators for the production of the aromatic polyestercarbonates include, aside from the monophenols already mentioned, the chlorocarbonic esters thereof and the acyl chlorides of aromatic monocarboxylic acids, which may optionally be substituted by C₁- to C₂₂-alkyl groups or by halogen atoms, and aliphatic C₂- to C₂₂-monocarbonyl chlorides.

The amount of chain terminators is in each case 0.1 to 10 mol %, based on moles of diphenol in the case of the phenolic chain terminators and on moles of dicarbonyl dichloride in the case of monocarbonyl chloride chain terminators.

In the production of aromatic polyestercarbonates, one or more aromatic hydroxycarboxylic acids may additionally be used.

The aromatic polyestercarbonates may either be linear or be branched in a known manner (see in this respect DE-A 2 940 024 and DE-A 3 007 934), with preference being given to linear polyestercarbonates.

Branching agents used may for example be tri- or polyfunctional carbonyl chlorides, such as trimesoyl trichloride, cyanuric trichloride, 3,3′,4,4′-benzophenonetetracarbonyl tetrachloride, 1,4,5,8-naphthalenetetracarbonyl tetrachloride or pyromellitic tetrachloride, in amounts of 0.01 to 1.0 mol % (based on dicarbonyl dichlorides used) or tri- or polyfunctional phenols, such as phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis [4,4-bis(4-hydroxyphenyl)cyclohexyl]propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl) propane, tetra(4-[4-hydroxyphenylisopropyl]phenoxy) methane, 1,4-bis [4,4′-dihydroxytriphenyl)methyl]benzene, in amounts of 0.01 to 1.0 mol % based on diphenols used. Phenolic branching agents may be initially charged with the diphenols; acyl chloride branching agents may be introduced together with the acyl dichlorides.

The proportion of carbonate structural units may be varied as desired in the thermoplastic aromatic polyestercarbonates. The proportion of carbonate groups is preferably up to 100 mol %, in particular up to 80 mol %, particularly preferably up to 50 mol %, based on the sum total of ester groups and carbonate groups. Both the ester fraction and the carbonate fraction of the aromatic polyestercarbonates may be present in the form of blocks or in random distribution in the polycondensate.

The thermoplastic aromatic polycarbonates and polyestercarbonates may be used alone or in any desired mixture.

Used as component A is preferably linear polycarbonate, further preferably based on exclusively bisphenol A.

### Component B

As component B, the composition comprises a polyester based on at least one aromatic or at least one cycloaliphatic dicarboxylic acid or mixtures thereof and cyclohexanedimethanol and optionally at least one further aliphatic diol. Mixtures of several of such polyesters may also be used.

“Based” here means that the polyester is for example produced by polymerization of the dicarboxylic acid mentioned or of an ester thereof with the diols mentioned. The polyester thus comprises structural units derived from an aromatic or cycloaliphatic dicarboxylic acid and from cyclohexanedimethanol and optionally from a further aliphatic diol.

Suitable aromatic or cycloaliphatic dicarboxylic acids are for example terephthalic acid radicals, phthalic acid, isophthalic acid, naphthalene-2,6-dicarboxylic acid, 4,4′-diphenyldicarboxylic acid, 2,5-furandicarboxylic acid and cyclohexanedicarboxylic acid.

Mixtures of different dicarboxylic acids may also be used; for example, use may be made of a mixture of terephthalic acid and up to 25 mol % of a further dicarboxylic acid.

The polyester preferably comprises only structural units derived from terephthalic acid and isophthalic acid as dicarboxylic acid, most preferably only from terephthalic acid.

In the production of the polyesters, it is possible to proceed either from terephthalic acid and the further acids mentioned or from alkyl esters or anhydrides of the corresponding acids.

As further aliphatic diols in addition to cyclohexanedimethanol, use may for example be made of ethylene glycol, butane-1,3-diol, butane-1,4-diol, propane-1,2-diol, propane-1,3-diol, pentane-1,5-diol, hexane-1,6-diol, isosorbide and tetramethylcyclobutanediol. Ethylene glycol is preferred.

In a further preferred embodiment, isosorbide and ethylene glycol are also used in addition to cyclohexanedimethanol; the polyester is thus constructed from three diol components in addition to the acid component.

Particularly preferably, component B is a polyester based on terephthalic acid and a mixture of cyclohexanedimethanol and ethylene glycol. Further preferably, the molar ratio of cyclohexanedimethanol to ethylene glycol is in the range from 40:60 to 80:20.

The production of the polyesters according to component B is known. It may be effected by esterification in the presence of a catalyst such as a zinc compound with subsequent polycondensation. A vacuum may be applied and the reaction may be performed for example at a temperature between 150° C. and 300° C.

Further catalysts containing titanium, germanium, tin, aluminum or antimony and mixtures of different catalysts may be used in the polycondensation.

The reaction may be performed continuously or batchwise. The raw materials may be metered in separately or premixing may be performed.

The polyesters according to component B have a weight-average molecular weight M_{w} of preferably 10 to 100 kg/mol, for example measured by gel permeation chromatography in 1,1,1,3,3,3-hexafluoro-2-propanol at a concentration of 1 g/l using polymethyl methacrylate as standard.

Furthermore, the polyesters preferably have a melt volume flow rate (MVR) of 20-80 cm³/10 min, preferably of 30 to 70 cm³/10 min, in each case measured according to ISO 1133 (2012) at 270° C. and a load of 5 kg.

The production of a polyester according to component B is described for example in “Modern Polyesters: Chemistry and Technology of Polyesters and Copolyesters”, (edited by J. Scheirs and T. E. Long, John Wiley & Sons, Ltd 2003) and the prior art cited therein. One suitable commercially available polyester is for example Skygreen™ JN100 (SK Chemicals Co., Ltd, Korea).

A further suitable commercially available polyester is for example ECOZEN™ T120 (SK Chemicals Co., Ltd, Korea).

### Component C

Used as component C in the composition according to the invention is a phosphorus-containing flame retardant, preferably selected from the groups of mono- and oligomeric phosphoric and phosphonic esters and phosphazenes, it also being possible to use mixtures of several compounds selected from one or more of these groups as flame retardants.

Preferred mono- and oligomeric phosphoric and phosphonic esters are phosphorus compounds of the general formula (4)

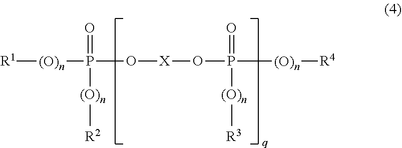

in which
R¹, R², R³ and R⁴ are each independently optionally halogenated C₁- to C₈-alkyl, in each case optionally alkyl-substituted, preferably C₁- to C₄-alkyl-substituted, and/or halogen-substituted, preferably chlorine- or bromine-substituted, C₅- to C₆-cycloalkyl, C₆- to C₂₀-aryl or C₇- to C₁₂-aralkyl,
n is independently 0 or 1,
q is 0 to 30 and
X is a mono- or polycyclic aromatic radical having 6 to 30 carbon atoms, or a linear or branched aliphatic radical having 2 to 30 carbon atoms, which may be OH-substituted and may contain up to 8 ether bonds.

Preferably, R¹, R², R³ and R⁴ are independently C₁- to C₄-alkyl, phenyl, naphthyl or phenyl-C₁-C₄-alkyl. The aromatic R¹, R², R³ and R⁴ groups may in turn be substituted by halogen and/or alkyl groups, preferably chlorine, bromine and/or C₁- to C₄-alkyl. Particularly preferred aryl radicals are cresyl, phenyl, xylenyl, propylphenyl or butylphenyl, and the corresponding brominated and chlorinated derivatives thereof.

X in formula (4) is preferably a mono- or polycyclic aromatic radical having 6 to 30 carbon atoms. The latter is preferably derived from diphenols.

n in formula (4) may independently be 0 or 1; preferably n is 1.

q has values of 0 to 30. When mixtures of different components of formula (4) are used, it is possible to use mixtures preferably number-average q values of 0.3 to 10, particularly preferably 0.5 to 10, in particular 1.05 to 1.4, most preferably 1.05 to 1.2.

X is particularly preferably

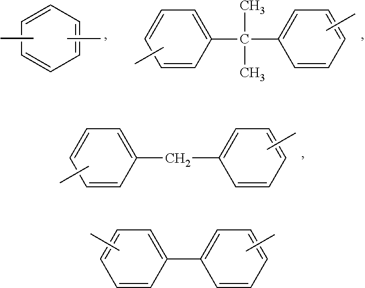

or the chlorinated or brominated derivatives thereof; in particular, X is derived from resorcinol, hydroquinone, bisphenol A or diphenylphenol. Particularly preferably, X is derived from bisphenol A.

Monophosphates (q=0), oligophosphates (q=1-30) or mixtures of mono- and oligophosphates may be used as component C according to the invention.

Monophosphorus compounds of formula (1) are especially tributyl phosphate, tris(2-chloroethyl) phosphate, tris(2,3-dibromopropyl) phosphate, tri(2-ethylhexyl) phosphate, triphenyl phosphate, tricresyl phosphate, diphenyl cresyl phosphate, diphenyl octyl phosphate, diphenyl 2-ethylcresyl phosphate, tri(isopropylphenyl) phosphate, halogen-substituted aryl phosphates, dimethyl methylphosphonate, diphenyl methylphosphonate, diethyl phenylphosphonate, triphenylphosphine oxide or tricresylphosphine oxide.

One particularly preferred phosphorus compound according to component C is bisphenol A-based oligophosphate of formula (5).

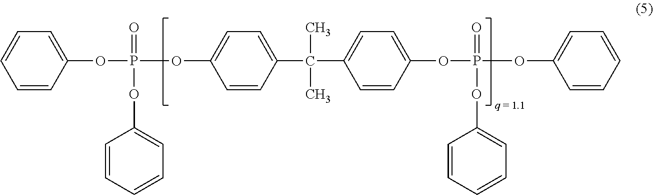

The phosphorus compounds of formula (4) are known (cf. for example EP-A 363 608, EP-A 640 655) or can be produced in an analogous manner by known methods (for example Ullmanns Enzyklopädie der technischen Chemie [Ullmann's Encyclopedia of Industrial Chemistry], vol. 18, p. 301 ff. 1979; Houben-Weyl, Methoden der organischen Chemie [Methods of Organic Chemistry], vol. 12/1, p. 43; Beilstein vol. 6, p. 177).

The average q values can be determined by using a suitable method (gas chromatography (GC), high pressure liquid chromatography (HPLC), gel permeation chromatography (GPC)) to determine the composition of the phosphate mixture (molecular weight distribution) and using this to calculate the average values for q.

Phosphazenes are compounds of formulae (6) and (7)

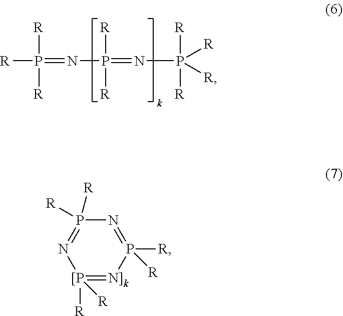

in which
R in each case is identical or different and is amino, in each case optionally halogenated, preferably fluorine-halogenated, C₁- to C₈-alkyl, or C₁- to C₈-alkoxy, in each case optionally alkyl-substituted, preferably C₁- to C₄-alkyl-substituted, and/or halogen-substituted, preferably chlorine- and/or bromine-substituted, C₅- to C₆-cycloalkyl, C₆- to C₂₀-aryl, preferably phenyl or naphthyl, C₆- to C₂₀-aryloxy, preferably phenoxy, naphthyloxy, or C₇- to C₁₂-aralkyl, preferably phenyl-C₁-C₄-alkyl,
k is 0 or a number from 1 to 15, preferably a number from 1 to 10.

Examples include propoxyphosphazene, phenoxyphosphazene, methylphenoxyphosphazene, aminophosphazene and fluoroalkylphosphazenes. Phenoxyphosphazene is preferred.

The phosphazenes can be used alone or in a mixture. The R radical may always be the same, or two or more radicals in formulae (6) and (7) may be different. Phosphazenes and the production thereof are described for example in EP-A 728 811, DE-A 1 961668 and WO 97/40092.

### Component D

One or more representatives selected from the group consisting of polymer additives and polymeric blend partners may optionally be present in the composition as component D.

The polymer additives or polymeric blend partners are preferably selected from the group consisting of anti-drip agents, flame retardant synergists, smoke inhibitors, lubricants and mold-release agents, nucleating agents, antistats, conductivity additives, stabilizers, flow promoters, fillers and reinforcers, phase compatibilizers, impact modifiers, further polymeric constituents different from components A and B (for example functional blend partners), and dyes and pigments.

Examples of impact modifiers are: Graft polymers with core-shell structure and a graft base comprising polybutadiene rubber such as ABS and MBS, with a graft base comprising acrylate rubber or silicone rubber or with a silicone acrylate rubber graft base such as the Metablen™ types from Mitsubishi Rayon Co., Ltd.; olefin-acrylate copolymers such as Elvaloy™ types from DuPont or Paraloid™ types from Dow.

In a preferred embodiment, at least one polymer additive selected from the group consisting of lubricants and mold-release agents and stabilizers is used as component D.

In a preferred embodiment, at least one representative selected from the group consisting of sterically hindered phenols, organic phosphites, phosphorous acid and organic or inorganic Brønsted acids is used as stabilizer.

In a preferred embodiment, fatty acid esters, particularly preferably fatty acid esters of pentaerythritol or glycerol, are used as lubricants and mold-release agents.

In a further preferred embodiment, component D comprises at least one graft polymer with core-shell structure and/or a rubber-free vinyl (co)polymer, further preferably in an amount of together 1% to 10% by weight, based on the composition comprising components A, B, C and D.

Particularly preferably, use is made of graft polymers with core-shell structure and a graft base comprising polybutadiene rubber.

A styrene-acrylonitrile copolymer is particularly preferably used as rubber-free vinyl (co)polymer.

The amount and the type of components D must of course be selected such that the flame retardancy and the CTI are not significantly impaired.

Production of a Molding Compound from the Composition

A thermoplastic molding compound can be produced from the composition comprising the components A, B and C and optionally D according to the invention.

The thermoplastic molding compound can be produced for example by mixing the respective constituents of the composition in a known manner and melt-compounding and melt-extruding the mixture at temperatures of preferably 200° C. to 320° C., particularly preferably at 240° C. to 300° C., very particularly preferably at 260° C. to 290° C., in customary apparatuses such as internal kneaders, extruders and twin-screw extruders.

In the context of this application, this process is generally referred to as compounding.

“Molding compound” is thus understood to mean the product obtained when the constituents of the composition are melt-compounded and melt-extruded.

The individual constituents of the composition can be mixed in a known manner, either successively or simultaneously, either at about 20° C. (room temperature) or at higher temperature. This means that, for example, some of the constituents may be introduced via the main intake of an extruder and the remaining constituents may be introduced later in the compounding process via a side extruder.

The molding compounds may be used to produce molded articles. These may for example be produced by injection molding, extrusion and blow-molding processes. A further form of processing is the production of molded articles by thermoforming from previously produced sheets or films. The molding compounds are particularly suitable for processing in extrusion, blow-molding and thermoforming processes.

It is also possible to meter the constituents of the compositions directly into the conveying extruder of an injection molding machine, to produce the molding compound in the conveying extruder and to process the molding compound directly into molded articles by correspondingly discharging said compound into an injection mold (compounding or reactive compounding injection moulding).

The present invention thus further relates to the use of a composition according to the invention or of a molding compound for producing molded articles, and furthermore also to a molded article that is obtainable from a composition according to the invention or from a molding compound or that contains such a molding compound. A molding in the sense according to the invention may also be an insulation layer in an electrical component such as a transistor. In particular, the molded article is the component described above, which further preferably is an electrical/electronic component.

The component is preferably a part of a (high-) voltage switch, (high-) voltage inverter, relay, electronic connector, electrical connector, circuit breaker, a photovoltaic system, an electric motor, a heat sink, a USB plug, a charger or charging plug for electric vehicles, an electrical junction box, a smart meter housing, a miniature circuit breaker or a busbar. It is likewise possible for the component to be the entire element and not only a part thereof.

A component according to the invention may for example be produced by injection molding with overmolding of metallic conductor tracks. Metallic conductor tracks are fixed preassembled in the cavity of the injection molding tool. After the tool is closed, the conductor tracks are flooded with polymer melt under high pressure, this creating a composite when cooled. After solidifying and demolding, the finished component can be used.

An alternative is integrated plastic-metal injection molding (IKMS). This involves producing the finished component in two steps. In the first step, the plastic component with the conductor tracks that will be filled subsequently is produced. The finished plastic component is then placed in a second cavity and filled with solder, this constituting the conductor tracks when solidified.

A further alternative is the subsequent connection of an injection-molded component to the conductor tracks, i.e. the plastic component is produced in the injection mold and assembled with the conductor in a further step. The injection-molded component can be connected during assembly via a further input of energy. There are multiple methods for this; for instance, the metallic conductor can be heated so strongly that it can be pressed into the plastic component. The conductor can however also be connected directly to the plastic component by means of laser welding.

Further embodiments of the present invention are listed below.

1. A composition comprising
A) 60% to 93% by weight of at least one aromatic polycarbonate, polyestercarbonate or mixtures thereof,
B) 2% to 20% by weight of a polyester based on at least one aromatic or at least cycloaliphatic dicarboxylic acid or mixtures thereof and cyclohexanedimethanol and optionally a further aliphatic diol,
C) 1% to 10% by weight of at least one phosphorus-containing flame retardant.

2. The composition according to embodiment 1, characterized in that component B is an amorphous polyester.

3. The composition according to embodiment 1 or 2, characterized in that the ratio of the proportion by weight of component B in the composition to the proportion by weight of phosphorus in the composition is less than 40, preferably greater than 5 to less than 40.

4. The composition according to any of the preceding embodiments, characterized in that component B is a polyester based on terephthalic acid and cyclohexanedimethanol and ethylene glycol.

5. The composition according to embodiment 4, characterized in that the molar ratio of cyclohexanedimethanol to ethylene glycol is 40:60 to 80:20.

6. The composition according to any of the preceding embodiments, characterized in that component B is based on a mixture of cyclohexanedimethanol, ethylene glycol and isosorbide as diol component.

7. The composition according to any of the preceding embodiments, characterized in that component C is selected from the group consisting of mono- and oligomeric phosphoric and phosphonic esters, phosphazenes and mixtures of these compounds.

8. The composition according to any of the preceding embodiments, characterized in that used as component C is a compound of the general formula (4)

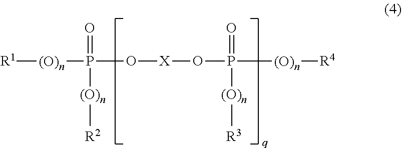

in which
R¹, R², R³ and R⁴ are each independently optionally halogenated C1- to C8-alkyl, in each case optionally alkyl-substituted, preferably C1- to C4-alkyl-substituted, and/or halogen-substituted, preferably chlorine- or bromine-substituted, C5- to C6-cycloalkyl, C6- to C20-aryl or C7- to C12-aralkyl,
n is independently 0 or 1,
q is 0 to 30 and
X is a mono- or polycyclic aromatic radical having 6 to 30 carbon atoms, or a linear or branched aliphatic radical having 2 to 30 carbon atoms, which may be OH-substituted and may contain up to 8 ether bonds.

9. The composition according to any of the preceding embodiments, comprising
65% to 90% by weight of component A
3% to 18% by weight of component B
2% to 9% by weight of component C.

10. The composition according to any of the preceding embodiments, comprising
70% to 90% by weight of component A
4% to 16% by weight of component B
3% to 9% by weight of component C.

11. The composition according to any of the preceding embodiments, further comprising, as component D, 0.1% to 20% by weight of at least one polymer additive from the group consisting of anti-drip agents, flame retardant synergists, smoke inhibitors, lubricants and mold-release agents, nucleating agents, antistats, conductivity additives, stabilizers, flow promoters, fillers and reinforcers, phase compatibilizers, impact modifiers, further polymeric constituents different from components A and B, and dyes and pigments.

12. The composition according to embodiment 11, wherein the composition comprises, as component D, at least one graft polymer with core-shell structure and/or rubber-free vinyl (co)polymer in an amount of together 1% to 10% by weight.

13. The composition according to embodiment 11 or 12, wherein the graft polymer with core-shell structure has a core comprising polybutadiene rubber.

14. The composition according to any of the preceding embodiments, consisting of components A to D.

15. The use of 2% to 20% by weight of a polyester based on an aromatic or cycloaliphatic dicarboxylic acid or mixtures thereof and cyclohexanedimethanol and optionally a further aliphatic diol and 1% to 10% by weight of at least one phosphorus-containing flame retardant for improving the CTI and the flame retardancy according to UL 94 V of polycarbonate compositions.

16. The use according to embodiment 15, wherein a CTI of 600 V determined according to the rapid test method based on IEC 60112:2009 and a UL 94 V0 classification at a test specimen thickness of 1.5 mm of polycarbonate compositions comprising 60% to 93% by weight of polycarbonate is attained.

17. The use according to embodiment 16, wherein the polycarbonate composition comprises 65% to 90% by weight of polycarbonate and wherein 3% to 18% by weight of a polyester based on an aromatic or cycloaliphatic dicarboxylic acid or mixtures thereof and cyclohexanedimethanol and optionally a further aliphatic diol and 2% to 9% by weight of at least one phosphorus-containing flame retardant are used.

18. The use according to embodiment 16, wherein the polycarbonate composition comprises 70% to 90% by weight of polycarbonate and wherein 4% to 16% by weight of a polyester based on an aromatic or cycloaliphatic dicarboxylic acid or mixtures thereof and cyclohexanedimethanol and optionally a further aliphatic diol and 3% to 9% by weight of at least one phosphorus-containing flame retardant are used.

19. A component
comprising
a first electrical conductor L1 and a second electrical conductor L2 at a first distance d1 and a second distance d2 with respect to one another,
which are connected via a thermoplastic material M which is in direct contact with the first electrical conductor and the second electrical conductor,
wherein the distance d1 is the shortest distance between the first electrical conductor and the second electrical conductor along the surface of the thermoplastic material M and
wherein the distance d2 is the shortest distance between the first electrical conductor and the second electrical conductor through the air,
wherein d2 is selected in such a way that at the respective operating voltage U for the component a sparkover through the air is prevented,
   wherein d1, at the operating voltage U listed below, has the following values:

$$d 1 ( 0 V \leq U \leq 250 V ) : 1.3 mm to < 2.5 mm \\ d 1 ( 250 V < U \leq 500 V ) = 2.5 mm to < 5. mm \\ d 1 ( 500 V < U \leq 1000 V ) = 5. mm to < 10. mm$$

and wherein the thermoplastic material M comprises the following components
A) 60% to 93% by weight of at least one aromatic polycarbonate, polyestercarbonate or mixtures thereof,
B) 2% to 20% by weight of a polyester based on an aromatic or cycloaliphatic dicarboxylic acid or mixtures thereof and cyclohexanedimethanol and optionally a further aliphatic diol,
C) 1% to 10% by weight of at least one phosphorus-containing flame retardant.

20. The component according to embodiment 19, wherein the component has an IP6K9K degree of protection according to ISO 20653:2013 and wherein d1, at the operating voltages U listed below, has the following values:

$$d 1 ( 0 V \leq U \leq 250 V ) : 1.3 mm to < 2.5 mm \\ d 1 ( 250 V < U \leq 500 V ) = 2.5 mm to < 5. mm \\ d 1 ( 500 V < U \leq 1000 V ) = 5. mm to < 10. mm .$$

21. The component according to embodiment 20, wherein d1, at the operating voltages U listed below, has the following values:

$$d 1 ( 0 V \leq U \leq 250 V ) : 1.3 to < 1.8 mm \\ d 1 ( 250 V < U \leq 500 V ) = 2.5 to < 3.6 mm \\ d 1 ( 500 V < U \leq 1000 V ) = 5. to < 7.1 mm$$

22. The component according to any of embodiments 19 to 21, wherein d2 is at least 1.2 mm.

23. The component according to any of embodiments 19 to 22, wherein d2 is 1.2 to 10.0 mm.

24. The component according to any of embodiments 19 to 23, wherein the thermoplastic material M comprises
65% to 90% by weight of component A
3% to 18% by weight of component B
2% to 9% by weight of component C.

25. The component according to any of embodiments 19 to 24, wherein the thermoplastic material M comprises
70% to 90% by weight of component A
4% to 16% by weight of component B
3% to 9% by weight of component C.

26. The component according to any of embodiments 19 to 25, wherein it is an electrical/electronic component.

27. The component according to any of embodiments 19 to 26, wherein it is a part of a (high-) voltage switch, (high-) voltage inverter, relay, electronic connector, electrical connector, circuit breaker, a photovoltaic system, an electric motor, a heat sink, a USB plug, a charger or charging plug for electric vehicles, an electrical junction box, a smart meter housing, a miniature circuit breaker or a busbar.

### EXAMPLES

### Component A-1:

Linear polycarbonate based on bisphenol A having a weight-average molecular weight M_{w} of 26 000 g/mol (determined by GPC in methylene chloride with polycarbonate based on bisphenol A as standard).

### Component A-2:

Linear polycarbonate based on bisphenol A having a weight-average molecular weight M_{w} of 24 000 g/mol (determined by GPC in methylene chloride with polycarbonate based on bisphenol A as standard).

### Component B

Skygreen™ JN100 (SK Chemicals Co., Ltd, Korea): copolyester based on terephthalic acid, cyclohexanedimethanol, ethylene glycol and diethylene glycol in a molar ratio of 44.4:30.7:23.7:1.1 having a weight-average molecular weight M_{w} of 46 000 g/mol (determined by GPC in hexafluoroisopropanol with polymethyl methacrylate as standard) and a melt volume flow rate (MVR) of 51 cm³/[10 min], measured according to ISO 1133 (2012 version) at a temperature of 270° C. and a load of 5 kg.

### Component C

Bisphenol A-based oligophosphate according to the following structure (Chemtura Manufacturing UK Limited)

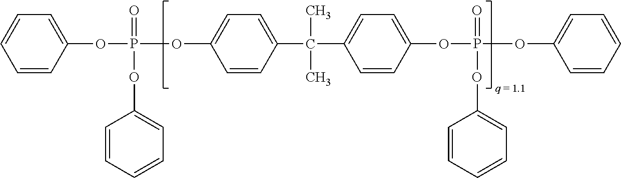

### Component D-1

Pentaerythritol tetrastearate as mold-release agent, Cognis Oleochemicals GmbH, Germany

### Component D-2

Dimeric phosphonite Irgafos™ P-EPQ, tetrakis(2,4-di-tert-butylphenyl)-1,1-biphenyl-4,4′-diyl bisphosphonit, BASF (Germany)

### Component D-3

Sterically hindered phenol Irganox™ 1076, octadecyl 3-[3,5-di-tert-butyl-4-hydroxyphenyl]propionate, BASF (Germany)

### Component D-4

Cycolac™ INP449: polytetrafluoroethylene (PTFE) preparation from Sabic, consisting of 50% by weight of PTFE present in an SAN copolymer matrix.

### Component D-5

Phosphorous acid, H₃PO₃, Sigma-Aldrich Chemie GmbH, Germany

Production and Testing of the Molding Compounds Made from the Compositions

The components were mixed in a Coperion ZSK-26 Mc18 twin-screw extruder at a melt temperature of 250° C.-280° C. The molded articles were produced at a melt temperature of 270° C. and a mold temperature of 70° C. in an Arburg 270 E injection molding machine.

The IZOD impact strength was determined at room temperature on test rods with dimensions of 80 mm×10 mm×4 mm according to ISO 180-U (2019 version).

The Vicat softening temperature was measured according to DIN ISO 306 (Method B with 50 N load and a heating rate of 120 K/h, 2013 version) on a test rod which had been injection-molded from one side and with dimensions of 80×10×4 mm.

The flame retardancy was assessed according to UL94V on rods with dimensions of 127×12.7×1.5 mm.

The tracking resistance was tested for the compositions described here according to the rapid test method based on IEC 60112:2009. To this end, a 0.1% ammonium chloride test solution (395 ohm*cm resistance) was applied dropwise, between two neighboring electrodes spaced apart by 4 mm, to the surface of test specimens of dimensions 60 mm×40 mm×4 mm at a time interval of 30 s. A test voltage was applied between the electrodes and was varied over the course of the test. The first test specimen was tested at a starting voltage of 300 V or 350 V. A maximum of 50 drops (one drop every 30 s) in total were applied per voltage as long as no tracking current >0.5 A over 2 s occurred or the sample burned. After 50 drops, the voltage was increased by 50 V and a new test specimen was tested at this higher voltage, according to the procedure described above. This process was continued until either 600 V was reached or a tracking current or burning occurred. If one of the above-mentioned effects already occurred with fewer than 50 drops, the voltage was reduced by 25 V and a new test specimen was tested at this lower voltage. The voltage was reduced until the test was passed with 50 drops without tracking current or burning. This procedure was therefore used to determine the maximum possible voltage at which a composition was able to withstand 50 drops of the test solution without occurrence of a tracking current. Lastly, four further test specimens were tested at the determined maximum voltage with 50 drops each for confirmation. This confirmed value is reported as the CTI in the examples. A 100-drop value was not determined, hence “rapid test method based on” the specified standard.

TABLE 1
Compositions according to the invention and properties thereof

| | 1 | 2 | 3 | 4 |
|---|---|---|---|---|
| | 1504-A | 1504-B | 1506-A | 1506-B |
| Components | | | | |
| [% by weight] | | | | |
| A-1 | 84.28 | 79.28 | 80.28 | 75.28 |
| A-2 | 5.00 | 5.00 | 5.00 | 5.00 |
| B | 5.00 | 10.00 | 5.00 | 10.00 |
| C | 4.00 | 4.00 | 8.00 | 8.00 |
| D-1 (PETS) | 0.6 | 0.6 | 0.6 | 0.6 |
| D-2 (Irgafos P-EPQ) | 0.1 | 0.1 | 0.1 | 0.1 |
| D-3 (Irganox 1076) | 0.2 | 0.2 | 0.2 | 0.2 |
| D-4 (PTFE/SAN masterbatch) | 0.8 | 0.8 | 0.8 | 0.8 |
| D-5 (phosphorous acid) | 0.02 | 0.02 | 0.02 | 0.02 |
| B/phosphorus ratio | 14 | 28 | 7 | 14 |
| Properties | | | | |
| Izod impact strength [kJ/m²] | n.f. | n.f. | n.f. | n.f. |
| Vicat softening temperature [° C.] | 121 | 118 | 110 | 107 |
| Flame retardancy according to | V-0 | V-0 | V-0 | V-0 |
| UL94 V at 1.5 mm | | | | |
| Tracking resistance [V] | 600 | 600 | 600 | 600 |

n.f. means “no fracture”

The data from Table 1 show that test specimens made from the compositions according to the invention have a high CTI, very good flame retardancy, and high heat distortion resistance and impact strength.

TABLE 2
Noninventive compositions and properties thereof

| | V5 | V6 | V7 | V8 | V9 |
|---|---|---|---|---|---|
| | 1504-D | 1506-D | 1503-A | 1503-B | 1503-D |
| Components | | | | | |
| [% by weight] | | | | | |
| A-1 | 59.28 | 55.28 | 76.28 | 71.28 | 51.28 |
| A-2 | 5.00 | 5.00 | 5.00 | 5.00 | 5.00 |
| B | 30.00 | 30.00 | 5.00 | 10.00 | 30.00 |
| C | 4.00 | 8.00 | 12.00 | 12.00 | 12.00 |
| D-1 (PETS) | 0.6 | 0.6 | 0.6 | 0.6 | 0.6 |
| D-2 (Irgafos P-EPQ) | 0.1 | 0.1 | 0.1 | 0.1 | 0.1 |
| D-3 (Irganox 1076) | 0.2 | 0.2 | 0.2 | 0.2 | 0.2 |
| D-4 (PTFE/SAN | 0.8 | 0.8 | 0.8 | 0.8 | 0.8 |
| masterbatch) | | | | | |
| D-5 (phosphorous acid) | 0.02 | 0.02 | 0.02 | 0.02 | 0.02 |
| B/phosphorus ratio | 84 | 42 | 5 | 9 | 28 |
| Properties | | | | | |
| Izod impact strength | n.f. | 244 | 151 | 143 | 137 |
| [kJ/m²] | | | | | |
| Vicat softening | 106 | 95 | 102 | 100 | 89 |
| temperature [° C.] | | | | | |
| Flame retardancy | V-2 | V-2 | V-0 | V-0 | V-0 |
| according to UL94 | | | | | |
| V at 1.5 mm | | | | | |
| Tracking | 600 | 600 | 275 | 300 | 375 |
| resistance [V] | | | | | |

n.f. means “no fracture”

The data from Table 2 show that test specimens made from the noninventive compositions do not achieve the desired properties. If the proportion of component B is too high, as in V5 and V6, then it is not possible to achieve the required flame retardancy, even with an increased amount of component C. In this case (V6), the heat distortion resistance is additionally reduced. If the proportion of component C is increased even further, then it is indeed possible to improve the flame retardancy again (V9), but the heat distortion resistance is very low. In addition, the tracking resistance (CTI) is no longer sufficient. Examples V7 and V8, in which the proportion of component C is also too high, likewise exhibit a low tracking resistance. Furthermore, all examples with too high a proportion of component C exhibit an insufficient impact strength, i.e. a fracture is observed in each case (V7, V8 and V9).

1. A composition comprising
A) 60% to 93% by weight of at least one aromatic polycarbonate, polyestercarbonate or mixtures thereof,
B) 2% to 20% by weight of a polyester based on at least one aromatic or at least one cycloaliphatic dicarboxylic acid or mixtures thereof and cyclohexanedimethanol and optionally at least one further aliphatic diol,
C) 1% to 10% by weight of at least one phosphorus-containing flame retardant.

2. The composition as claimed in claim 1, characterized in that component B is an amorphous polyester.

3. The composition as claimed in claim 1, characterized in that the ratio of the proportion by weight of component B in the composition to the proportion by weight of phosphorus in the composition is greater than 5 to less than 40.

4. The composition as claimed in claim 1, characterized in that component B is a polyester based on terephthalic acid and cyclohexanedimethanol and ethylene glycol.

5. The composition as claimed in claim 4, characterized in that the molar ratio of cyclohexanedimethanol to ethylene glycol is 40:60 to 80:20.

6. The composition as claimed in claim 1, characterized in that component B is based on a mixture of cyclohexanedimethanol, ethylene glycol and isosorbide as diol component.

7. The composition as claimed in claim 1, characterized in that component C is selected from the group consisting of mono- and oligomeric phosphoric and phosphonic esters, phosphazenes and mixtures of these compounds.

8. The composition as claimed in claim 1, characterized in that used as component C is a compound of the general formula (4) 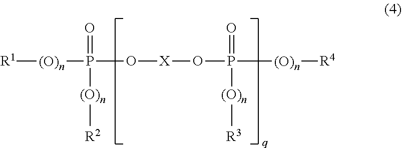
in which
R¹, R², R³ and R⁴ are each independently optionally halogenated C1- to C8-alkyl, in each case optionally alkyl-substituted, and/or halogen-substituted, C5- to C6-cycloalkyl, C6- to C20-aryl or C7- to C12-aralkyl,
n is independently 0 or 1,
q is 0 to 30 and
X is a mono- or polycyclic aromatic radical having 6 to 30 carbon atoms, or a linear or branched aliphatic radical having 2 to 30 carbon atoms, which may be OH-substituted and may contain up to 8 ether bonds.

9. The composition as claimed in claim 1, comprising
65% to 90% by weight of component A
3% to 18% by weight of component B
2% to 9% by weight of component C.

10. The composition as claimed in claim 1, further comprising, as component D, 0.1% to 20% by weight of at least one polymer additive from the group consisting of anti-drip agents, flame retardant synergists, smoke inhibitors, lubricants and mold-release agents, nucleating agents, antistats, conductivity additives, stabilizers, flow promoters, fillers and reinforcers, phase compatibilizers, impact modifiers, further polymeric constituents different from components A and B, and dyes and pigments.

11. The composition as claimed in claim 10, wherein the composition comprises, as component D, at least one graft polymer with core-shell structure and/or rubber-free vinyl (co)polymer in an amount of together 1% to 10% by weight.

12-13. (canceled)

14. A component comprising a first electrical conductor L1 and a second electrical conductor L2 at a first distance d1 and a second distance d2 with respect to one another,
which are connected via a thermoplastic material M which is in direct contact with the first electrical conductor and the second electrical conductor,
wherein the distance d1 is the shortest distance between the first electrical conductor and the second electrical conductor along the surface of the thermoplastic material M and
wherein the distance d2 is the shortest distance between the first electrical conductor and the second electrical conductor through the air,
wherein d2 is selected in such a way that at the respective operating voltage U for the component a sparkover through the air is prevented,
wherein d1, at the operating voltage U listed below, has the following values:
$$d 1 ( 0 V \leq U \leq 250 V ) : 1.3 mm to < 2.5 mm \\ d 1 ( 250 V < U \leq 500 V ) = 2.5 mm to < 5. mm \\ d 1 ( 500 V < U \leq 1000 V ) = 5. mm to < 10. mm$$
and wherein the thermoplastic material M comprises the following components
A) 60% to 93% by weight of at least one aromatic polycarbonate, polyestercarbonate or mixtures thereof,
B) 2% to 20% by weight of a polyester based on an aromatic or cycloaliphatic dicarboxylic acid or mixtures thereof and cyclohexanedimethanol and optionally a further aliphatic diol,
C) 1% to 10% by weight of at least one phosphorus-containing flame retardant.

15. The component as claimed in claim 14, wherein the component has an IP6K9K degree of protection according to ISO 20653:2013 and wherein d1, at the operating voltages U listed below, has the following values:
$$d 1 ( 0 V \leq U \leq 250 V ) : 1.3 mm to < 2.5 mm \\ d 1 ( 250 V < U \leq 500 V ) = 2.5 mm to < 5. mm \\ d 1 ( 500 V < U \leq 1000 V ) = 5. mm to < 10. mm .$$
